(19) United States
(12) Patent Application Publication
(10) Pub. No.: US 2008/0224482 A1
(43) Pub. Date: Sep. 18, 2008

(54) Electrical Door Latch

(76) Inventors: Francesco CUMBO, Pisa (Pi) (IT); Marco Taurasi, Livorno (IT); Franco Giovanni Ottino, S. Giuliano Terme (IT); Marco Marlia, Guasticce Collesalvetti, (Li) (IT)

Correspondence Address: MAGNA INTERNATIONAL, INC., 337 MAGNA DRIVE, AURORA, ON, L4G-7K1, CA

(21) Appl. No.: 12/031,869

(22) Filed: Feb. 15, 2008

Related U.S. Application Data
(60) Provisional application No. 60/890,066, filed on Feb. 15, 2007.

(51) Int. Cl. E05C 3/16

(52) U.S. Cl. 292/216; 292/201

(57) ABSTRACT

A latching apparatus may have a normal mode of operation in which a mechanical signal is employed to actuate a door pawl, and hence to release a door latch ratchet. An electrical actuator may be employed to send that mechanical signal, and operation of the actuator may be governed by an electronic control unit (ECU). The latch apparatus may also have a second, or emergency, mode of operation in which a second mechanical signal path is employed either to cause an augmented force to be employed to release the pawl, or to cause a sudden impulse to urge the pawl to release, the sudden impulse being driven by a release of energy from an energy storage device, in particular a mechanical energy storage device. The apparatus may include either an electrical or a mechanical door handle interrupt to prevent unwanted activation. The device may also include an auxiliary electrical back-up power source in the event of a main power source failure.

This application claim the benefits of U.S. Provisional Application No. 60/890,066, filed Feb. 15, 2007.

### FIELD OF THE INVENTION

The present application relates to the filed of door latches, and, in particular, of door latches such as may be employed in automotive apparatus.

### BACKGROUND OF THE INVENTION

One of the defining characteristics of an electrical door latch (E-latch) is that it does not have a mechanical linkage to an outside or inside door handle. Instead, the door is released by an actuator, in response to an electrical signal coming from the handles. In case of a crash, the force to release the door could increase and the actuator may not have enough force for the operation.

It therefore desired to provide a mechanical storage force able to release the latch when reaction forces on the ratchet increases (for example after crash). In such a solution, it would also be useful to enable the release actuator to release the latch with conventional lower forces.

### SUMMARY OF THE INVENTION

In an aspect of the the invention there is a door latch apparatus. It has a ratchet, a co-operating pawl, a primary pawl release, a secondary pawl release, and an actuator. The ratchet is movable between an open position in which a mating striker can be engaged and disengaged therefrom, and a closed position in which the mating striker is captured thereby. The pawl is movable between a first position preventing movement of the ratchet from the closed position to the open position, and a second position permitting movement of the ratchet from the closed position to the open position, whereby to permit release of the striker. The actuator is connected in a first path to cause the primary pawl release to urge the pawl to the second position. The actuator is connected in a second path to cause the secondary pawl release to urge the pawl to the second position. The actuator is operable to transmit a release signal along the second path in the event that the pawl is not released when a release signal is transmitted along the first drive path.

In an additional feature of that aspect of the invention the apparatus includes an energy storage device, and the energy storage device is mounted to urge the pawl to move to the second position when the actuator transmits a signal along the second path. In another feature, the second path includes a mechanical force transformer operable to apply a greater force to urge the pawl to the second position when activated along the second path than along the first path. In a further additional feature, the actuator is operable in a first direction to transmit a signal along the first path, and in a second, opposite, direction to transmit a signal along the second path. In another feature, one of (a) the first path; and (b) the second path includes a speed reduction gear train. In yet another feature, the latch apparatus includes a time sensor and a release sensor, and the apparatus is operable to transmit a first mechanical signal along the first path, operable to test for release of the door latch over a period of time, and operable to transmit a second mechanical signal along the second path after expiry of that time period.

In still another feature, at least the second path has a path interrupt, and at least one door handle input member operable to close the path interrupt. In a further additional feature, both the first and second paths have a path interrupt, and at least one door handle input member operable to close that interrupt. In still another feature the second path has both an inside door handle input member and an outside door handle input member, and either of the input members is operable to close the path interrupt. In yet again another feature, both the first and second paths have a respective path interrupt, and both an outside door handle input member and an outside handle input member, either of the handle input members being operable to close the interrupt.

In another feature, the door latch has an externally accessible reset. In a further feature, the externally accessible reset is one of (a) a mechanical reset; and (b) an electrical reset. In still another feature the actuator is operable to re-energize the energy storage member following transmission of a release signal along the second path. In still yet another feature, the energy storage member is an emergency release spring.

In another aspect of the invention there is a door latch. The door latch has a ratchet and pawl assembly; a sector lever; an emergency release spring for urging the sector lever to act against the pawl to release the ratchet; a sector pawl biased to check sector lever from engaging the pawl; and a motorized actuator operable in a first mode to act directly against the pawl to release the ratchet and operable in a second mode to disengage the sector pawl from checking the sector lever.

In a feature of that aspect of the invention the actuator is operable to reset the latch following operation of the latch in the second mode. In another feature, operation of the latch is governed by an electronic control unit. In still another feature, the electronic control unit is programmed to release the latch in the first mode, to wait for a first set time period to sense that the latch is unlatched; if that time period expires without sensing an unlatched condition, then to operate in the second mode. In a further feature, the electronic control unit is programmed to wait a second time period, and then to drive the latch to a reset condition.

In another aspect of the invention there is a door latch. The door latch has a motorized release actuator, the actuator having an output element; and a catch movable between an engaged position in which the release actuator is precluded from moving even if the motor of the release energizer is actuated and a disengaged position wherein the actuator output is free to move. The catch is mechanically linked to at least one of (a) an inside door handle and (b) an outside door handle. The catch is biased to the engaged position and movable to the disengaged position by a pull on either of the inside or outside door handles. In a feature of that aspect of the invention, the catch is a mechanical interrupt biased to prevent operation of the actuator unless the at least one handle is activated.

In still another aspect of the invention there is a door latch. It has a ratchet and pawl assembly; a first gear enabled to act against the pawl to release the ratchet; a reduction gear set mounted to act against the pawl to release the ratchet; and a release actuator. The release actuator is operable in a first direction to activate the first gear to release the pawl and operable being in a second direction to activated the reduction gear set to release the pawl. In another feature of that aspect of the invention, there is a lost motion connection between the first gear and the reduction gear set.

In a still further aspect of the invention there is a door system. It includes inside and outside handles mounted to a door; and a latch having an ECU and an electrically operated door release actuator. The inside and outside door handles are electrically connected to the ECU and release actuator. A receptacle is mounted in one of (a) the interior side of the door and (b) the exterior side of the door. The receptacle has an electrical contact, the receptacle being connected to at least the ECU. In a further feature, the door system includes an auxiliary recovery battery having a contact receivable in the receptacle.

In still yet another further aspect of the invention there is a latching system in a vehicle having a main battery. The latching system includes an electronic latch having a ratchet and a pawl, and a latch ECU. There is a switch installed between the battery and the ECU. The latching system includes an auxiliary battery connected to the latch ECU, the switch being actuated by the latch ratchet.

In another aspect of the invention there is a latching system in a vehicle having a main battery. The latching system includes an electronic latch having a ratchet and a pawl, and a latch ECU. There is an auxiliary battery connected to the latch ECU, and an anti-fuse member installed between the battery and ECU. The anti-fuse device is permanently closed after the main vehicle battery is wired to wires connected to the ECU.

In still yet another aspect of the invention there is a latching system for a vehicle having a main battery. The latching system includes an electronic latch having a ratchet and a pawl, a latch ECU, and at least two switches mounted to inhibit release of the latch, wherein both switches must be activated to permit the latch to open. A further feature of that aspect of the invention, includes the use thereof.

The various aspects of the invention may also include the use, or methods of use of the apparatus shown, described, or claimed herein. These and other aspects and features of the invention may be understood with reference to the description which follows, and with the aid of the illustrations of a number of examples.

### BRIEF DESCRIPTION OF THE FIGURES

The description is accompanied by a set of illustrative Figures in which:

FIG. 1a is a general arrangement plan view of a latch apparatus according to an aspect of the present invention;

FIG. 1b is a two-position illustration of the latch apparatus of FIG. 1a in a first mode of operation;

FIG. 1c is a two-position illustration of the latch apparatus of FIG. 1a in a second mode of operation;

FIG. 2 shows a plan view of an alternate embodiment of latch apparatus to that of FIG. 1a, having an inside or outside handle input member;

FIG. 3 is an illustration of the latch apparatus of FIG. 1a having a mechanical reset fitting;

FIG. 4 is a logic schematic for the latch apparatus of FIGS. 1a-1c;

FIG. 5 is a logic schematic for the latch apparatus of FIG. 3;

FIG. 6a shows a plan view of an alternate embodiment of latch apparatus to that of FIG. 1a employing a gear train;

FIG. 6b shows a two-position plan view of the latch apparatus of FIG. 6a in a first mode of operation;

FIG. 6c shows a two-position plan view of the latch apparatus of FIG. 6a in a second mode of operation;

FIG. 7 shows an external device for operating the latch of FIG. 1a or 6a;

FIG. 8 shows a schematic of a ratchet switch for the latch of FIG. 1a or 6a in series with a recovery power source;

FIG. 9 shows an anti-fuse device in series with the power source of FIG. 8;

FIG. 10 shows a schematic of a double switch release apparatus for the latch apparatus of FIG. 1a or FIG. 6a;

FIG. 11a is a perspective view of an alternate door latch apparatus to that of FIG. 1a having a gear train;

FIG. 11b is a reverse perspective view of the door latch apparatus of FIG. 11a;

FIG. 11c shows a portion of the gear train of FIG. 11a in a closed position in a first mode of operation;

FIG. 11d shows the gear train portion of FIG. 11c in a release position;

FIG. 11e shows the gear train of FIG. 11a in a closed position in a second mode of operation;

FIG. 11f shows the gear train of FIG. 11e in a release position in the second mode of operation;

FIG. 11g shows a manual reset position of the gear train of FIG. 11a;

FIG. 12a is an end view of a ratchet of the door latch apparatus of FIG. 11a;

FIG. 12b shows a plan view of the ratchet of FIG. 12a;

FIG. 12c shows an opposite end view of the ratchet of FIG. 12a;

FIG. 13a is a first plan view of a pawl lever of the apparatus of FIG. 11a;

FIG. 13b shows an end view of the pawl lever of FIG. 13a;

FIG. 13c shows an opposite plan view of the pawl lever of FIG. 13a;

FIG. 14a shows an end view of a pawl of the latch apparatus of FIG. 11a;

FIG. 14b shows a plan view of the pawl of FIG. 14a;

FIG. 14c shows an opposite end view of the pawl of FIG. 14a;

FIG. 15a shows a plan view of an emergency spring retainer of the latch apparatus of FIG. 11a;

FIG. 15b shows a top view of the spring retainer of FIG. 15a;

FIG. 15c shows an end view of the pawl of FIG. 15a;

FIG. 16a is a front plan view of a first gear of the apparatus of FIG. 11a;

FIG. 16b is a side view of the gear of FIG. 16a;

FIG. 16c shows a rear plan view of the pawl of FIG. 16a;

FIG. 17a is a front plan view of a second gear of the apparatus of FIG. 11a;

FIG. 17b is a side view of the gear of FIG. 17a;

FIG. 17c shows a rear plan view of the pawl of FIG. 17a;

FIG. 18a is a front plan view of a third gear of the apparatus of FIG. 11a;

FIG. 18b is a side view of the gear of FIG. 18a;

FIG. 18c shows a rear plan view of the pawl of FIG. 18a;

FIG. 19a is a front plan view of a fourth gear of the apparatus of FIG. 11a;

FIG. 19b is a side view of the gear of FIG. 19a;

FIG. 19c shows a rear plan view of the pawl of FIG. 19a;

FIG. 20a is a front plan view of a fifth gear of the apparatus of FIG. 11a;

FIG. 20b is a side view of the gear of FIG. 20a;

FIG. 20c shows a rear plan view of the pawl of FIG. 20a;

### DETAILED DESCRIPTION

The description that follows, and the embodiments described therein, are provided by way of illustration of an example, or examples, of particular embodiments of the principles, aspects or features of the present invention. These examples are provided for the purposes of explanation, and not of limitation, of those principles and of the invention. In the description, like parts are marked throughout the specification and the drawings with the same respective reference numerals. The drawings are generally to scale unless noted otherwise, although the scale may differ from drawing to drawing. Reference to directions such as up and down, front and back, left and right, top and bottom, may tend to be arbitrary, and these terms may be used for convenience rather than defining a required orientation, unless noted otherwise. The terminology used in this specification is thought to be consistent with the customary and ordinary meanings of those terms as they would be understood by a person of ordinary skill in the automobile industry in North America. The Applicant expressly excludes all interpretations that are inconsistent with this specification.

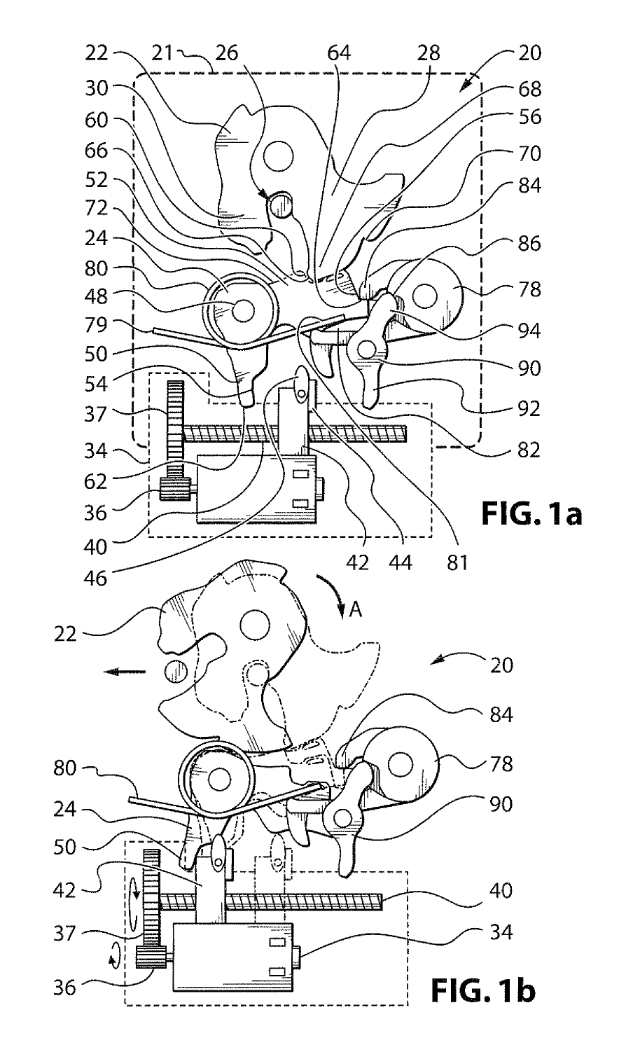

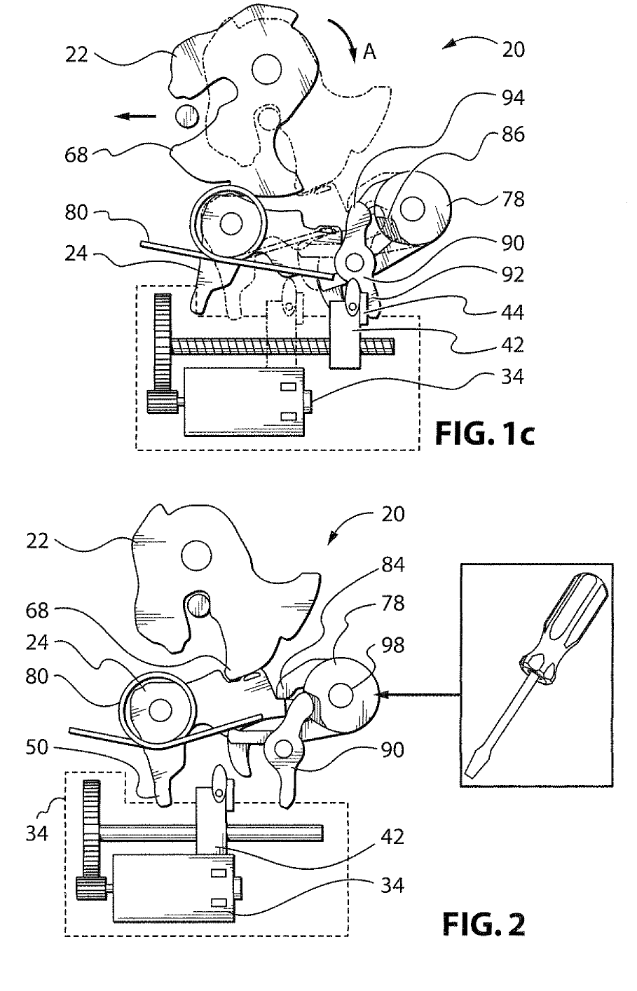

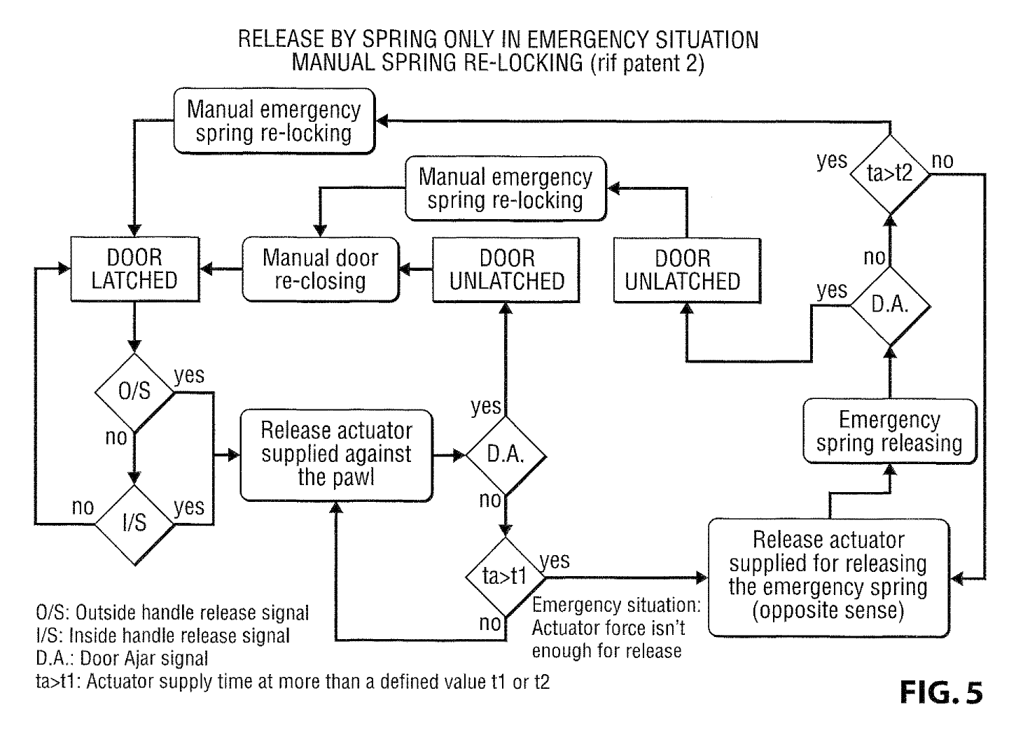

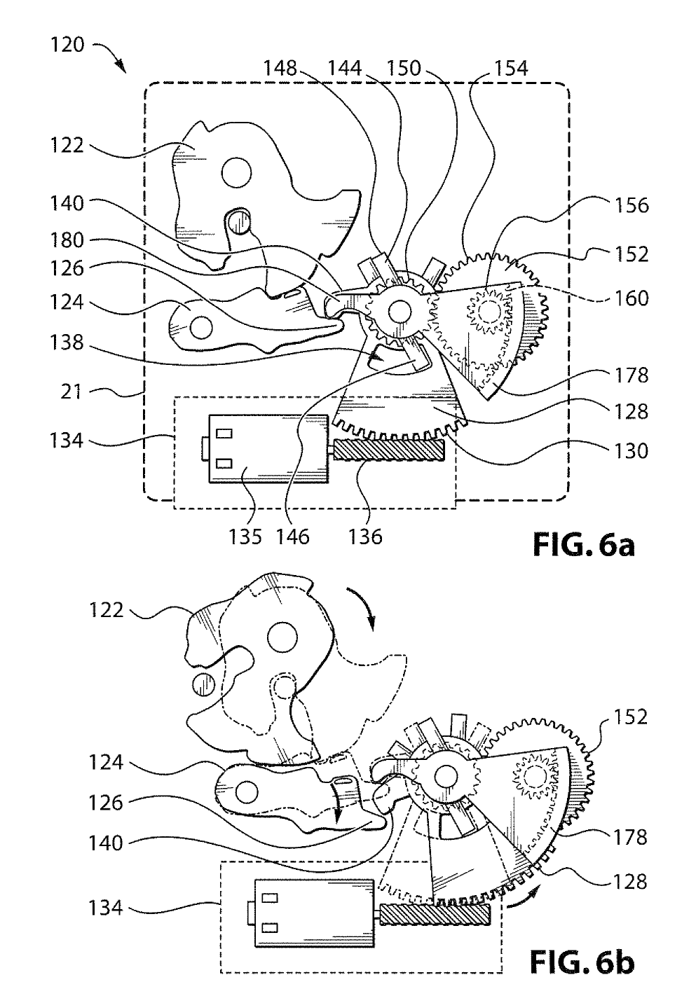

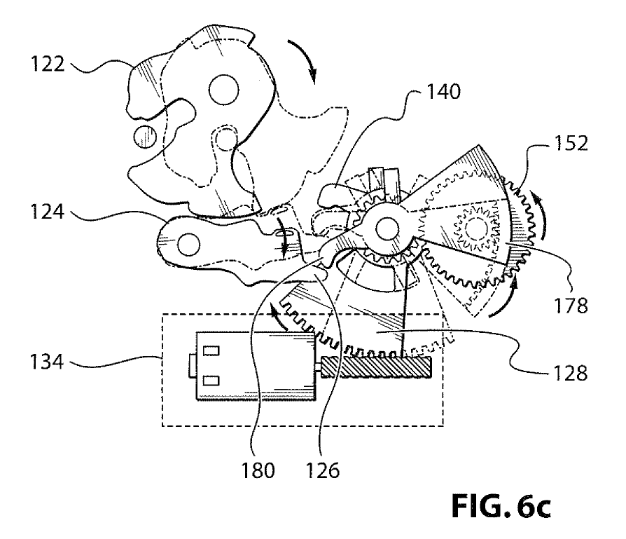

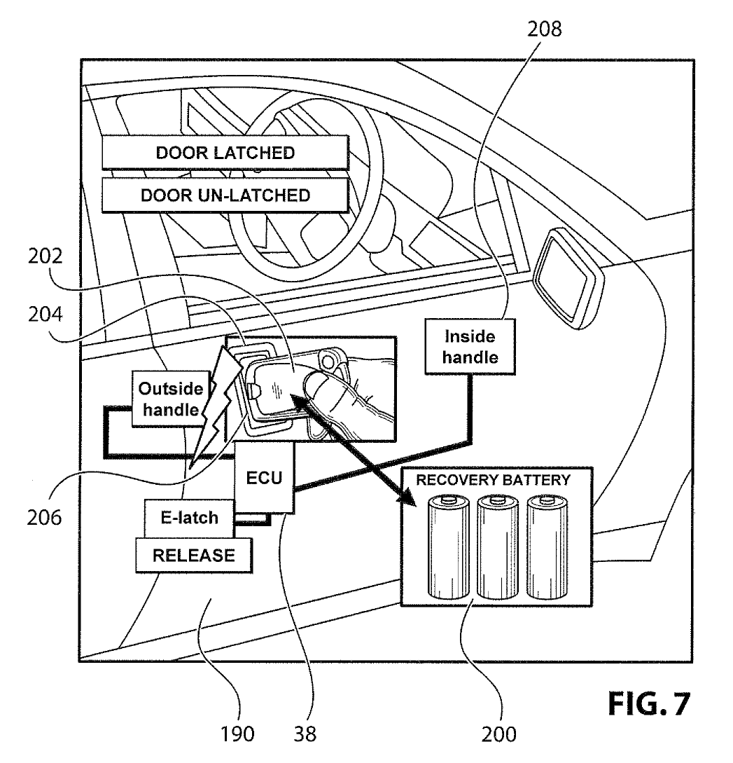

FIGS. 1a-1c show one embodiment of a latch or latch apparatus, however it may be termed, generally indicated as 20 in which release may occur through either a first mode or a second mode. Apparatus 20 may typically be a latch for an automobile, be it a door latch, a trunk latch, or some other. For the purposes of this description, the enclosure body, or cover, or housing of the latch is not shown, thus permitting the internal workings of the latch to be seen. It will, nonetheless, be understood that the latch includes a body or cover which may be of a suitable size and shape, whose presence is identified notionally in the illustrations by the dashed outline 21. The body, or cover, or housing 21 as may be, provides the reaction force for various retaining or biasing springs, and also provided the seats for axle or shaft members of the various rotating or pivoting members of the assembly, as described below. The apparatus includes a first striker securement fitting, which may be termed a claw or, commonly, a ratchet 22. It also includes a releasable catch, or holding member, identified as a pawl 24. The ratchet is movable between first and second positions, which may be identified as a release position, and an engaged position. In the release position, the ratchet is vacant. In the engaged position, a striker may be seated in, and held securely in, the accommodation 26 defined between the legs 28, 30 of ratchet 22. Ratchet 22 is most typically biased toward the open, or release, position by a return spring (not shown). Pawl 24 is used to prevent disengagement of ratchet 22 (i.e., movement toward the release position) by selectively engaging a stop or shoulder of ratchet 22. Pawl 24 is biased by a pawl spring toward the engaged position in which release of ratchet 22 is obstructed. When the user desires the latch to open, pawl 24 is urged toward a disengaged, or release position. In some instances, as in apparatus 20, an actuator 34 is employed to move pawl 24. In this example, actuator 34 has the form of an electrical motor driving a gear, identified as spur gear 36. The operation of actuator 34 is governed by an actuator governor, of which an example is electronic control unit (ECU) 38 (FIGS. 7-10). ECU 38 may be an analog or digital device. The logic use by ECU 38 is indicated in the algorithms of FIGS. 5 and 6.

Release actuator 34 may be operated in two different senses, or modes. In one sense, or mode, as depicted in FIG. 1b, actuator 34 is employed to transmit a mechanical signal to pawl 24 along a first transmission path, in this case a mechanical signal transmission path, to cause pawl 24 to move to its second, activated, position or activated state, or withdrawn or retracted state or position, (as opposed to its passive position under the default urging of its spring). In the other mode, or sense, as depicted in FIG. 1c, actuator 34 is employed to transmit a mechanical signal to pawl 24 along a second transmission path, which may also be a mechanical transmission path, once again to cause pawl 24 to move to its second position, and thereby to permit release of the ratchet 22 and any striker previously captured therein.

It may be that the first path is a low force, or low energy, signal transmission path, such that the ultimate force applied (and therefor torque applied) to pivot pawl 24 may be a normal, or customary, or usual (or low) force or torque path. Similarly, the second path may provide an augmented force, or torque (as may be), and may be defined as an high force or torque path. It may also be that the second path employs a rapid discharge of an energy storage device to provide a sudden impulse to dislodge pawl 24. That is, the first sense, or mode, may involve motion of the actuator in the opposite sense to which it is employed in the second mode: in one sense the actuator has a low force for release in normal situation; in the other sense the actuator activates an emergency pre-loaded force storage member or device for releasing a door such as may otherwise be secured by the mutually engaging interaction of the latch apparatus and a striker. Further, in at least one embodiment, the energy storage device can be reset by the same actuator after a release operation.

One context for the employment of apparatus 20 is that of a latch that is abnormally resistant to release. For example, the car or truck may have crashed. Normal operation of the latch (in the first mode) may not yield a successful release, so, after a suitable time interval (of the order of a second or a few seconds, perhaps) the latch is then operated in the second mode to apply a greater force or release of energy to release pawl 24. It may be noted that in the first mode (at least) the mechanically transmitted signal has two components or aspects. The first component is informational: a signal to open the pawl. The second component supplies the force that is intended to overcome the default bias of the spring and thereby to force the change of state in the position of the pawl according to the informational aspect of the signal. In the second mode it is not necessarily a transmission of force or torque, as may be) but rather the rapid release of an energy impulse that supplies the second component of the signal.

The Figures illustrate examples of mechanical means by which these first and second signal and force transmission paths may be defined. When a suitable voltage is applied across its terminals, pinion gear 36 of actuator 34 may drive a mating spur gear 37, and a gear screw identified as threaded shaft 40. A nut 42 is carried on threaded shaft 40 along a guideway that inhibits rotation of nut 42. Since shaft 40 has a fixed axis of rotation, nut 42 moves in linear translation therealong as shaft 40 turns. The nut may have mounted thereto an abutment, or finger 44, and a pivotable dog 46 that may be spring biased to the upright position shown in FIG. 1a. Dog 46 is prevented from rotating further in the clockwise direction by finger 44. Finger 44 and dog 46 are, in effect, output signal transmission members or arms by which signal outputs from actuator 34 may be transmitted to other members of the mechanism. In the alternative, the actuator can be a rotary actuator instead of a linear-style actuator, with the output lever rotating in two senses.

Pawl 24 has the form of a lever pivotally mounted to housing 21 on a central pin, as at 48. Pawl 24 has a first arm 50, and a second arm 52, and has three signal transmission interfaces, 54, 56 and 60. Signal transmission interface 54 has the form of a depending arm or finger 62 that stands in the path of finger 44, whence finger 62 may receive an input signal in the first mode of operation. Signal transmission interface 56 is also an input interface distant from pin 48 on arm 52, in the form of a finger, or abutment, cam, shoulder or socket 64, at which an input signal is received from a mating interface feature of a sector lever 78. Signal transmission interface 60 is the catch, shoulder, or abutment 66 of arm 52 upon which the finger, or foot, 68 of the radially distant extremity of ratchet 22 seats when ratchet 22 is in its primary, or fully cinched (i.e., fully closed) position. One may note that the outer periphery of ratchet 22 also has a secondary finger or foot 70 where the latch is partially engaged, and where cinching commences, and that the outer periphery of ratchet 22 and the outer surface 72 of pawl 24 between pin 48 and abutment 66 are mutually engaging such that when ratchet 22 moves from the release condition to the engaged condition, the one pushes the other out of the way.

A sector lever 78 is rotatably mounted in the latch housing 21. An energy storage member or device, in the nature of an emergency release spring 80 is also mounted in housing 21, with one end, 79 anchored to housing 21, and another end, 81, bearing against an input, or input interface as may be identified as arm 82 of sector lever 78. Sector lever 78 also has an output, or output interface, identified as an arm or finger, 84 that faces, and, in use, works in opposition against, an input interface, fitting, abutment, or seat 64 of pawl 24. That is, spring 80 has a long tail (end 81) that biases sector lever 78 to rotate counterclockwise (as viewed in FIG. 1a) and to push (via arm or finger 84) against pawl 24, to release ratchet 22. However, sector lever 78 also has another input interface, or abutment, or shoulder, or finger, or accommodation, identified as socket 86. A second signal transmitting member in the nature of a sector pawl 90 has a first arm 92 that stands in the path of output interface finger 44 of actuator 34, and a second arm 94 whose end is spring biased toward a matingly engaged position in socket 86. When so engaged, sector pawl 90 exerts a reactive torque on sector lever 78, and so prevents it from rotating in the counter clockwise direction. As such, finger 84 is checked by sector pawl 90 which is biased clockwise (biasing spring not shown) to hold sector lever 78 in the position shown in FIG. 1a.

The operation of the “normal” mode of the E-latch, i.e., latch apparatus 20, is schematically shown in FIG. 1b. In this drawing, stippled lines represent the initial position of components and the solid lines represent the final position of components. In the normal mode, actuator 34 is operated to move nut 42 leftward or upstream. This causes the actuator output to engage input arm 50, thereby rotating pawl 24 clockwise and thus releasing ratchet 22 (which also rotates clockwise). Sector lever 78 does not move since it is still checked by sector pawl 90. In this form of operation the force and signal transmission path runs from actuator 34 through pawl 24 to ratchet 22.

The operation of the second, or emergency release, mode of the E-latch of apparatus 20 is schematically shown in FIG. 1c. In this drawing, stippled lines once again represent the initial position of components and the solid lines represent the final position of components. In the emergency mode, actuator 34 is operated in the reverse direction, thus moving nut 42 rightward or downstream. This causes finger 44 to force sector pawl 90 to rotate counterclockwise, thereby disengaging second arm 94 from socket 86. When so disengaged, the action of emergency release spring 80, through the medium of tail 81, to release its energy in driving sector lever 78 counter-clockwise to bear against finger 62 of pawl 24. In so doing pawl 24 is driven clockwise to move abutment 66 out of the path of ratchet 22, thereby allowing it to rotate clockwise to the release position under the urging of its own release spring (i.e., the sector pawl rotates out of the sector socket).

After emergency release, actuator 34 is again operated to move nut 42 leftward or upstream back to its initial position. In so doing, dog 46 of the actuator output engages a depending tooth 96 of sector lever 78. This causes sector lever 78 to rotate clockwise against the urging force of emergency release spring 80 until sector pawl 90 once again is in position to maintain sector lever 78 in check. In this mode of operation the signal transmission path runs from actuator 34 through sector pawl 90, sector lever 78 and pawl 22.

FIG. 2 shows the control logic executed by the E-latch electronic control unit (ECU) in order to implement the foregoing. It may be understood that latch apparatus 22 may include a ratchet or striker end-of-travel position sensor that is triggered when the ratchet reaches its fully closed position. In the event that either (a) the ratchet or striker end of travel position sensor does not change state within a certain time, tₐ, following commencement of operation of actuator 34, or (b) actuator 34 stalls when it meets arm 50, as may be sensed by abnormal current draw in the electric motor of actuator 34, then the applied voltage across actuator 34 may be reversed to drive it in the other direction in the second mode of operation described above.

Accordingly, in one embodiment, as described, there is a latch having a ratchet and pawl assembly; a sector lever; an emergency release spring for urging the sector lever to act against the pawl to release the ratchet; a sector pawl biased to check the sector lever from engaging the pawl; and a motorized actuator. The motorized actuator is operable in a first mode to act directly against the pawl to release the ratchet and is operable in a second mode to disengage the sector pawl from checking the sector lever. In a further feature, the actuator is operable to reset the latch, and the emergency release energy storage member after the second mode of operation by utilizing the actuator. In another feature there is an ECU governing operation of the actuator according to the logic of FIG. 2.

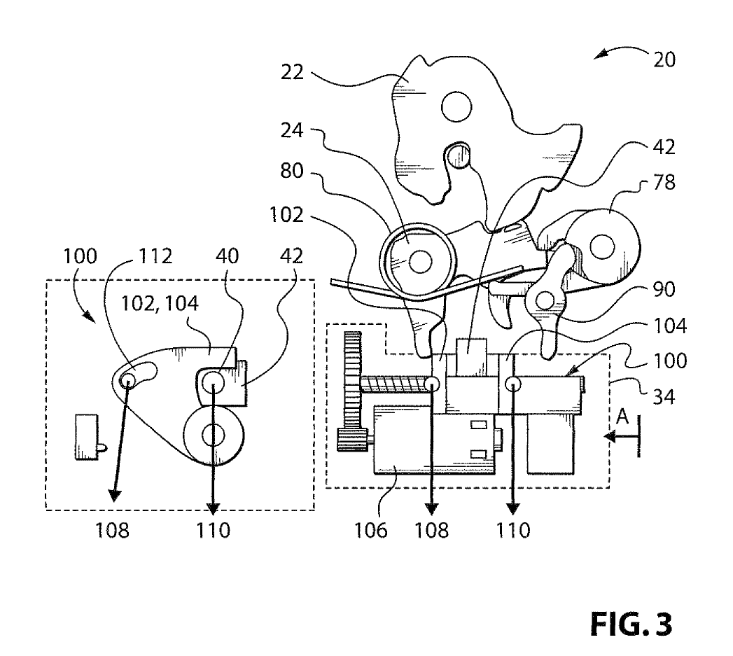

In an alternative to the embodiment shown in FIGS. 1a-1c and 2, once the emergency release spring is triggered, the E-latch may alternatively be reset by an external mechanical force. This alternative, is shown in FIG. 3. It recognizes that any recovery battery or other electrical storage means such as a capacitor that may have been used to power the ECU 38 and actuator 34 during emergency release could thereafter be discharged, and thus it is desired to re-set the storage force without using electrical operation. As schematically shown in FIG. 3, a reset fitting 98, such as a button for a screw driver, or a socket for an Allen key, or hex head for a socket set, or such like for a child lock reset can be provided. This fitting 98 may be located on sector lever 78. A screwdriver or other such device is then used mechanically to force sector lever 78 to rotate clockwise against the urging force of emergency release spring 50 until sector pawl 90 once again maintains sector lever 78 in check.

Thus, the latch apparatus may include an externally accessible mechanical reset member apparatus (and the use thereof employing a suitable tool, as may be) by which an external mechanical force may be applied to reset the E-latch after the second mode of operation. The Apparatus may also include an ECU and the corresponding ECU control logic.

In the foregoing embodiments, the E-latch has a release actuator that operates directly on the release kinematics of the latch. A possibility thus exists of an involuntary door release due to an errant signal from the ECU. FIG. 3 shows an embodiment of latch apparatus in which a mechanical interlock, coupled to the inside and outside door handles, prohibits the release actuator from operating until such time as at least one of the door handles is activated. That is, in FIG. 3, the operation of ratchet 22 and pawl 24, emergency release spring 80, sector lever 78, sector pawl 90 and actuator 34 are similar to that described with respect to the embodiment shown in FIG. 1a. Release actuator 34 however, is modified to incorporate a latch release interrupt member, or assembly, such as may be identified as catch, or catch assembly, 100 that can swivel in and out of the path of the actuator output (such as nut 42), thus precluding nut 42 from moving (when catch 100 is engaged) or enabling it to move linearly (when catch 100 is disengaged). The catch is biased to the engaged position in which protruding members in the nature of dogs 102, 104 obstruct the path of nut 42, preventing the actuator from operating. in the event that nut 42 runs against either dog 102 or 104, motor 106 may stall, or an over-current condition may be sensed by the ECU, and motor 106 shut off. Catch 100 is mechanically linked to the inside and outside handles indicated notionally as 108, 110 respectively, for example via cables, with a lost motion arc 112 in each slot such that motion of either cable pulling against, and overcoming, the default biasing spring will release catch 100. This, unless the inside or outside handle is pulled to release catch 100 and move it to its disengaged position, release actuator 34 will not operate even if actuator motor 106 is energized (in either direction).

Accordingly, in this embodiment there is a latch assembly that has a motorized release actuator. The release actuator has an output element and a catch movable between an engaged position in which the release actuator is precluded from moving even if the motor of the release energizer is actuated and a disengaged position wherein the actuator output is free to move, wherein the catch is mechanically linked to the inside and outside door handles, the catch being biased to the engaged position and movable to the disengaged position by a pull on either of the inside or outside door handles.

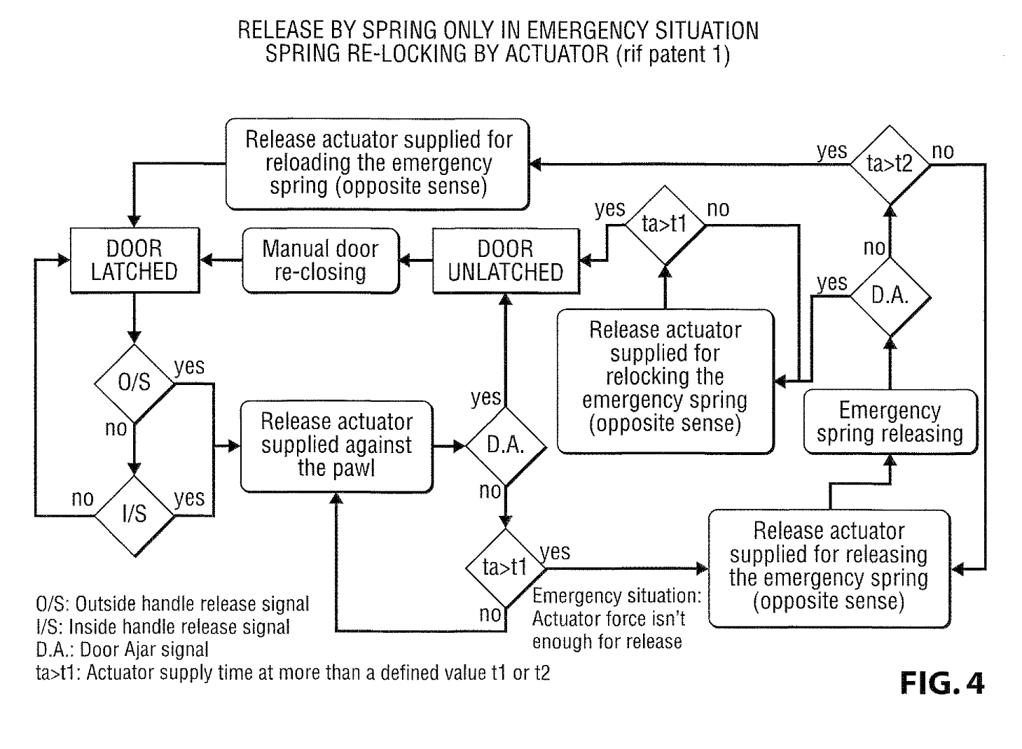

FIGS. 5 and 6 shows the control logic executed by the E-latch electronic control unit (ECU) in order to implement the foregoing in the embodiments of FIGS. 1a-1c, 2, 3 and 4, as may be. Starting with the “Door Latched” condition in FIG. 4, the ECU may poll for the pre-requisite condition of an attempt to open the door handle from either the inside or the outside of the vehicle. If this condition is met, the door handle interrupt is disengaged, and the actuator is activated in the first mode to release pawl 24, and allow ratchet 22 to open. The ECU then polls for the signal that the door is ajar (i.e., the end-of-travel sensor is off), as if the striker is not in place, or if the latch is only in the secondary condition. If the door is unlatched, it may be reclosed manually, and the process recommences at the “Door Latched” condition. In the event that the door is not ajar, (i.e., the ratchet of striker end-of-travel switch is still ‘On’) the ECU checks to see if the latch has timed out past the designated release time interval tₐ. If not, the ECU keeps the actuator running, and keeps polling for the door ajar signal. In the event that the ECU times out, tₐ being greater than the set time t₁, then the ECU drives actuator 34 in the opposite direction to initiate, or activate, the auxiliary, or emergency, or backup release mode. This should result in the release of the emergency spring. The ECU will then continue to poll for a change of state in the end-of-travel switch, indicating that the door is ajar. In the event that the door is ajar prior to timing out (again) the release actuator is driven in the other direction to recharge the spring, and to lock it in place with the sector level pawl 90. This condition is maintained for the length of time of the first set time, t₁. After this time the inference is that the door has been successfully unlatched, and the process stops, pending manual re-latching (i.e., closing, of the door). In the event that the door ajar condition is not found after the second time interval, t₂, has elapsed, the ECU will drive actuator 34 to reset the emergency release spring, and return to the start condition. This allows the process to repeat, and may result in second and subsequent attempts to release the catch by use of the emergency release spring.

The algorithm of FIG. 5 is substantially similar to that of FIG. 4 except that the process of resetting the emergency release spring is undertaken manually rather than by use of actuator 34.

FIGS. 6a, 6b and 6c show an alternate embodiment of release latch apparatus 120, for providing an enhanced mechanical force signal and drive train that is operable to release the latch when reaction forces on the ratchet increase (for example after a crash). In this embodiment, generally speaking, a release actuator 134 is operated in two opposite senses. In one sense release actuator 134 has a low force for urging pawl 124 to release in a normal situation. In the other sense, actuator 134 moves pawl 124 using reduction gears to obtain more force.

Referring to FIG. 6a, the E-latch includes a ratchet 122 and pawl 124, substantially as previously described. Pawl 124 does not have a depending input arm, but still has a bias spring tending to urge pawl 124 toward the position for engaging ratchet 122. Actuator 134 has a motor 135 driving a worm gear 136 that engages a sector-shaped pawl lever gear 128 that includes an outer gear portion 130 that meshes with worm gear 136. Lever gear 128 also includes a circumferentially extending opening, or slot, 138, whose ends define abutment interface surfaces. Gear 128 is rotatably mounted within a housing, symbolically represented as 21. The pawl lever gear has an arm 140 for engaging the input motion signal receiving interface arm 126 of pawl 124.

Apparatus 120 also includes a sector gear 178, analogous to sector lever 78, and has an arm 180 that is also mounted to work against the input interface of pawl 124. Sector gear 178 is part of a second drive train through the lost motion connection at slot 138. This second drive train includes an auxiliary gear 144 that has an input arm 146, a stop arm 148, and a set of teeth 150. There is a reduction gear 152, having a large externally toothed gear 154 that is engaged by, and driven by the teeth 150 of auxiliary gear 144. Reduction gear 152 includes an externally toothed pinion 156 for driving the internally toothed ring gear portion 160 of sector gear 178. Auxiliary gear 144 is rotatably mounted about the same axis as pawl lever gear 128 and intermeshes with reduction gear 152. Reduction gear 152 is rotatably mounted about a second axis, and has an output, namely pinion 156 that meshes with the sector gear ring gear portion 160. Sector gear 178 is also rotatably mounted about the same axis as pawl lever gear 128 and has arm 180 for engaging the pawl, as noted. As may be understood, the second mechanical signal transmission path through reduction gear 152 has quite a significant gear reduction, and hence a rather larger eventual output force disposed at the tip of arm 180, and so a correspondingly large emergency release torque developed in pawl 124.

The operation of the first or “normal” mode of the E-latch is schematically shown in FIG. 6b, in which stippled lines represent the initial position of components and the solid lines represent the final position of components. In the normal mode, actuator 134 is operated to rotate pawl lever gear 130 on pawl lever 128 counter-clockwise. This causes arm 180 of pawl lever 178 to push against and rotate pawl 124 clockwise and thus release ratchet 22 (which also rotates clockwise). The second drive train is not activated in this event, due to the lost motion connection—i.e., the circumferential extent of slot 138 exceeds the driven travel of pawl lever 128, such that no force or motion is transferred into the input arm of auxiliary gear 144. In the normal mode the mechanical signal path runs from actuator 134 through pawl lever 178 and pawl 124.

The operation of the emergency release mode of the E-latch apparatus 120 is schematically shown in FIG. 6c. In this drawing, stippled lines once again represent the initial position of components and the solid lines represent the final position of components. In the emergency mode, actuator 134 is operated to rotate pawl lever gear 128 clockwise (i.e., in the opposite direction to that of the first, or normal mode). As a result of inter-engagement of the abutment of the end of the lost-motion circumferential slot 138 on pawl lever gear 128, and finger 146 of auxiliary gear 144, the auxiliary gear 144 is driven rotationally clockwise. In turn, auxiliary gear 144 rotates reduction gear 152 counter-clockwise. Pinion 156 of reduction gear 152 drives ring gear portion 160 of sector gear 178 counter-clockwise. This forces output arm 180 of sector gear 178 to engage, and drive, arm 126 of pawl 124, moving pawl 124 clockwise, and output arm 180 on the sector gear 178 pushes against and rotates pawl 124 clockwise to release ratchet 122 which also rotates clockwise. After a suitable time interval (t₂, for example) actuator 134 can be driven in the opposite sense to reset sector gear 178, and to return pawl lever gear 128 to it original position. Any one or more of the components of the drive train may be biased (as by a return spring) to re-set the E-latch, or the actuator may likewise be energized to re-set the latch.

Accordingly, the embodiment of FIGS. 6a-6c shows a latch, or latch apparatus, that includes a ratchet and pawl assembly. A first gear is mounted to act against the pawl to release the ratchet through a first force transmission path. A reduction gear set is mounted to act against the pawl to release the ratchet through a second, amplified, force transmission path. The apparatus has, or is connected to be driven by, a release actuator. The actuator is operable in a first direction to activate the first gear to release the pawl and is operable in a second direction to activate the reduction gear set to release the pawl. The apparatus may include a lost motion connection between the first gear and the reduction gear set.

The E-latch may not have a mechanical linkage to outside and inside door handles. In case of a main battery failure, a recovery battery can be used to supply power to the latch ECU (integrated or not integrated on the latch) for unlock and release operations. In the event both a main battery and recovery battery failure, there is no way to release the door. In these circumstances an external electrical energy source may be provided to supply power to the latch ECU for door unlocking and release. FIG. 7 shows, schematically, an apparatus in which a recovery battery device is connected to either or both of the outside handle and the inside handle, which are also electrically connected to the ECU. As seen in FIG. 7, an auxiliary recovery battery, or battery pack, 200 may be contained within an housing, which may, in one example, have the form of a key fob 202. Key fob 202 has a metallic contact (e.g., a key) providing an electrical path, that is inserted into a socket 204 which may be part of an outside handle 206 (or inside handle, 208, as may be) mounted to a door 190. Socket 204, in turn, is electrically connected to the ECU 38 and to the release actuator, be it 34 or 134. The same construction applies also to the inside handle. Thus, in the event of emergency, the auxiliary battery provides electrical energy to operate the latch apparatus. Accordingly, to summarize, in the embodiment of FIG. 7 there is a door system that includes an inside handles, an outside handle and a latch. The door system includes an ECU and an electrically operated door release actuator. The inside and outside door handles are electrically connected to the ECU and to the release actuator. At least one of the interior and exterior sides of the door includes an electrical receptacle or coupling having an electrical contact, or contacts, to which an auxiliary power supply device, such as an auxiliary battery or battery pack, whether rechargeable or otherwise may be connected to provide power to the ECU and latch, as for emergency operation. The receptacle or coupling may be part of, or may be included in one or the other or both of, the inside and outside door handles.

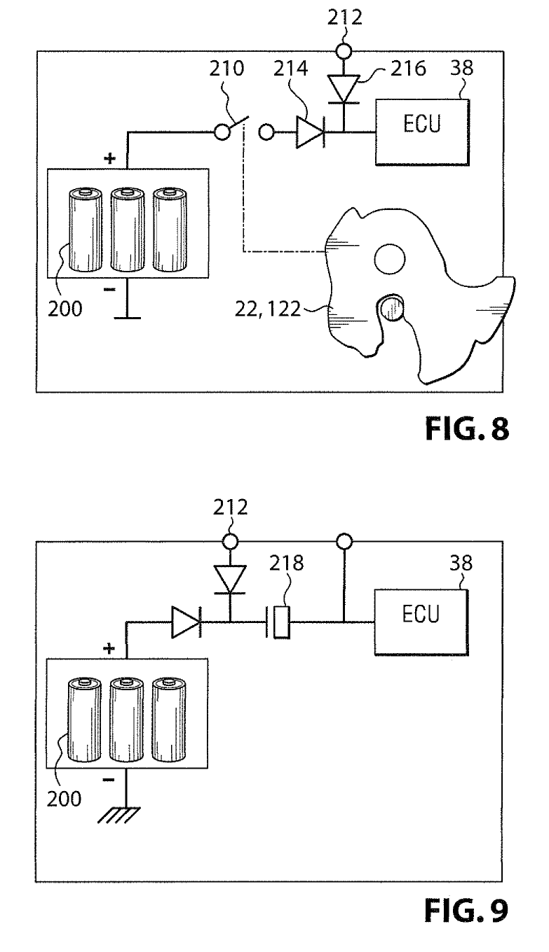

The electronic control unit (ECU) for an E-latch must be supplied with power even if the main battery of the vehicle has failed (whether or not the ECU is integrated into the latch). After the ECU assembly process, the ECU is still not connected to the main vehicle battery, hence emergency recovery or supplemental batteries will supply or at least be connected to the ECU, losing precious electrical energy in the process. The recovery batteries may be isolated from the latch ECU during assembly, shipping and handling. In one embodiment, as illustrated in FIG. 8, a ratchet switch 210 is installed in series between the recovery battery or battery pack, 200, and ECU 38. ECU 38 is also connected to the main vehicle battery 212 and diodes 214, 216 are installed as shown in order to prevent the main battery from charging the recovery battery or vice versa. Ratchet switch 210 is closed when ratchet 22 (or 122, as may be) is in a primary or secondary closed condition, and open when ratchet 22 is in the open position. During assembly, shipping and handling, ratchet 22 remains in the open state, and thus recovery batteries 200 are protected during this stage of manufacture until the latch is assembled on the vehicle door and vehicle body. This construction also prevents the recovery batteries from running down in the event the vehicle door is left open for extended periods of time. Accordingly, in summary, there is a recovery or auxiliary battery (in addition to the main vehicle battery) connected to a latch ECU and a switch installed between the battery and ECU. The switch is actuated by the latch ratchet.

Referring to FIG. 9, in another feature, that may be used in conjunction with the features of FIG. 8, an anti-fuse device 218 is installed between recovery battery 200 and ECU 38. So long as anti-fuse device 218 is open, recovery battery 200 cannot supply power to latch ECU 38. After door 190 is assembled on the vehicle, a voltage pulse is applied between PIN 1 and PIN 2 to close anti-fuse device 218 permanently and to connect recovery battery 200 to latch ECU 38. Thus, recovery batteries 200 can supply power to latch ECU 38 only after the vehicle is assembled (or until the vehicle main battery is connected to the wiring). Accordingly, in summary there is a recovery or auxiliary battery 200 connected to a latch ECU 38. Anti-fuse device 218 is installed between auxiliary battery 200 and ECU 38. Anti-fuse device 218 is permanently closed after the main vehicle battery 192 is wired to wires connected to ECU 38.

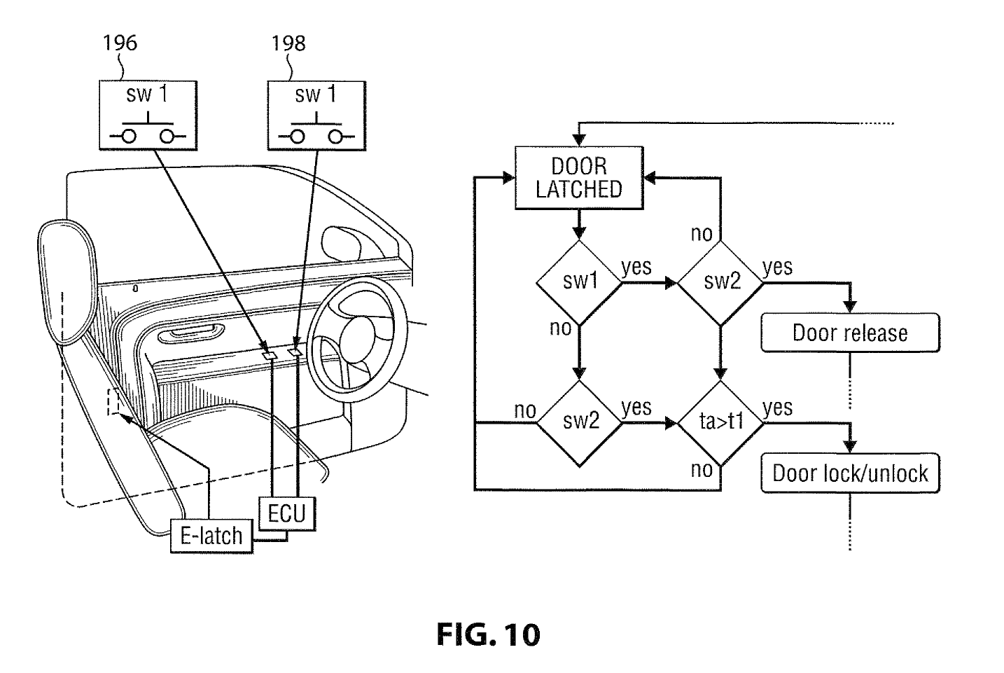

As previously discussed, in these embodiments the electric latch may not, or does not have a mechanical linkage to the outside and inside door handles. Instead, door 190 is released by actuator 34 in response to an electrical signal coming from a switch associated with the handles. If the user activates the inside release switch while driving, he or she can be in a dangerous situation. According to the embodiment shown in FIG. 10, two inside release switches 196, 198 are installed in the vehicle in an ergonomic position, such as on the interior side of door 190. As indicated in the algorithm of FIG. 10, only with the contemporaneous activation of both of switches 196 and 198 does ECU 38 command the latch apparatus, be it 20 or 120, to release. Either of switches 196, 198 can be used for inside lock-unlock function if pushed alone. Accordingly, in summary, there are two switches simultaneously activated to release the latch in emergency mode. In one feature, the activation of one of the switches to unlock the latch.

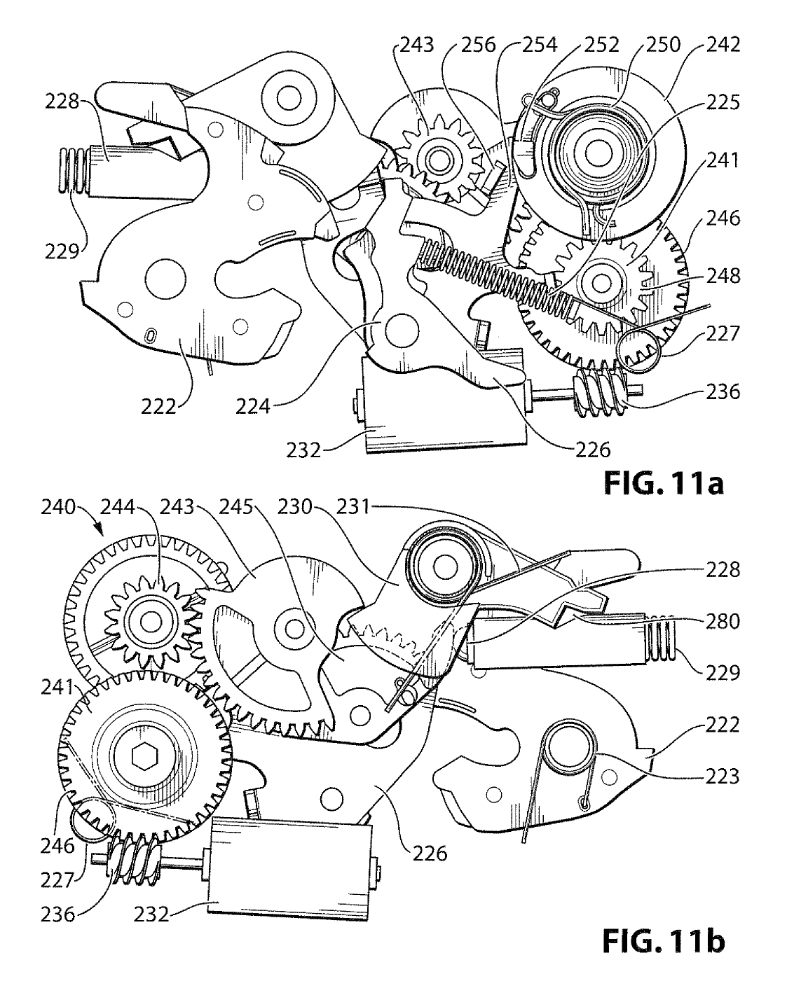

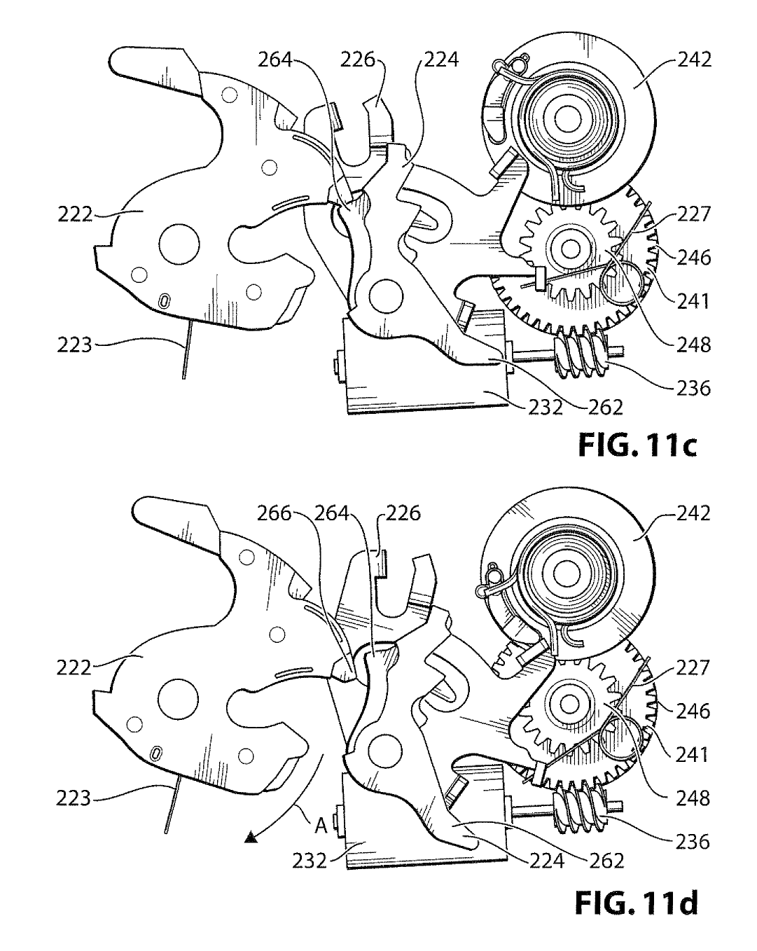

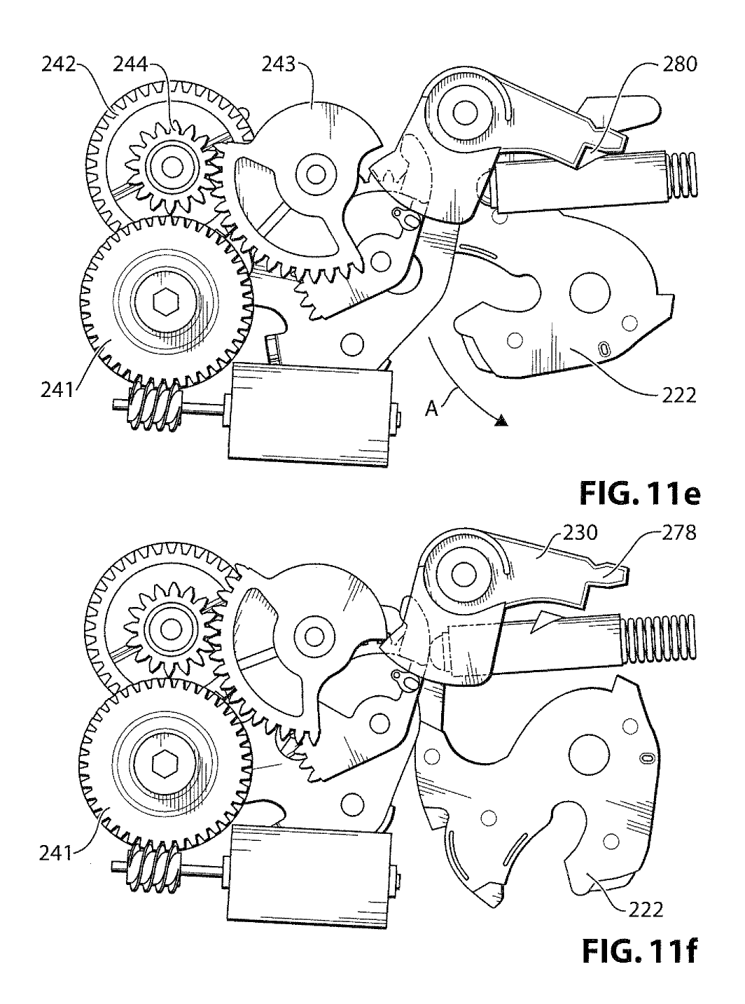

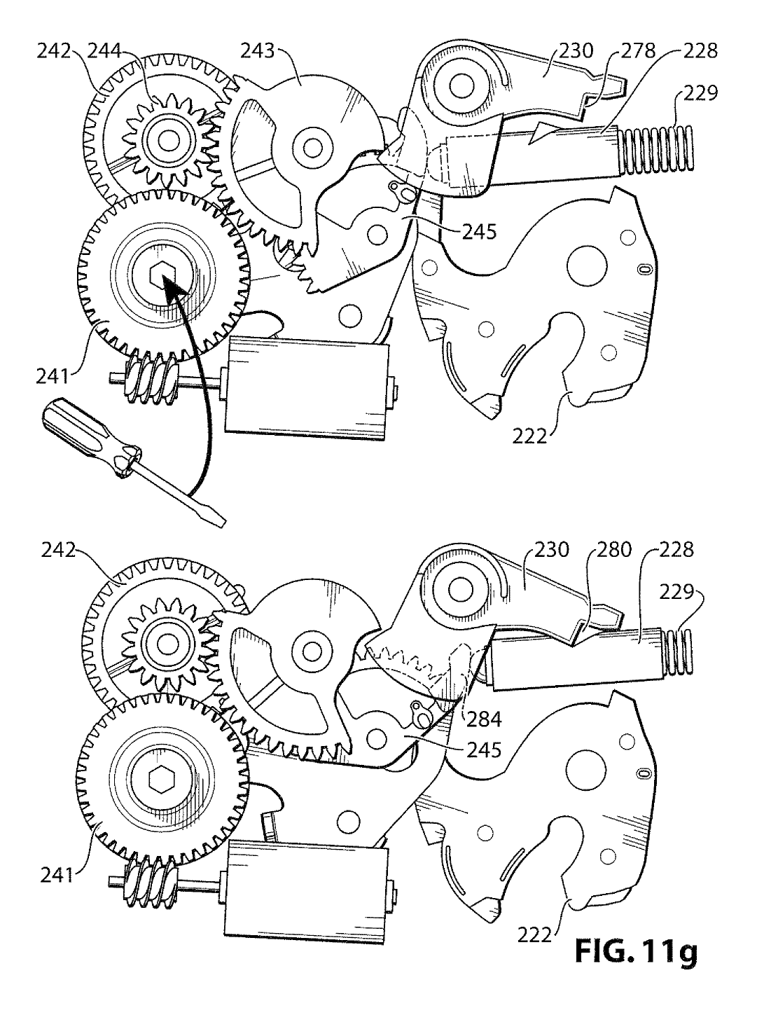

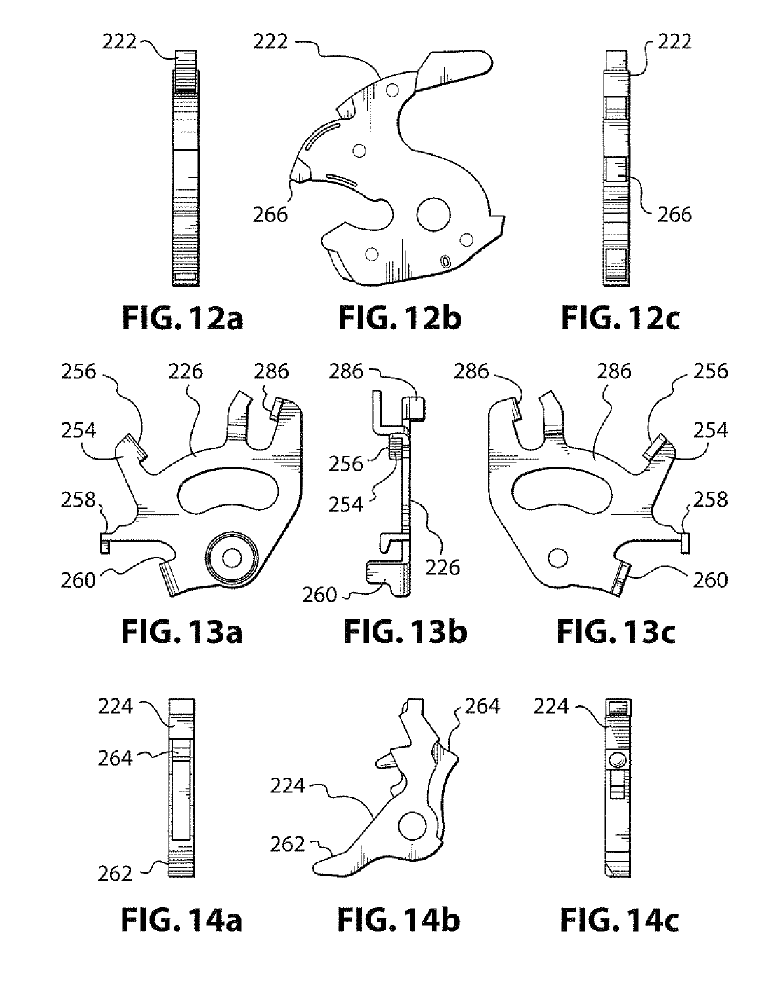

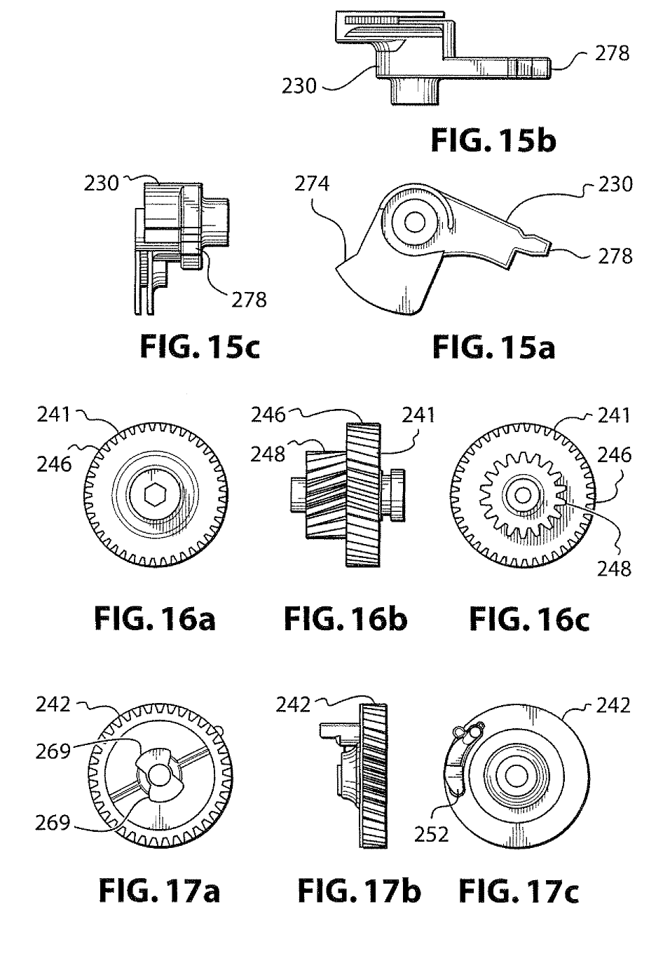

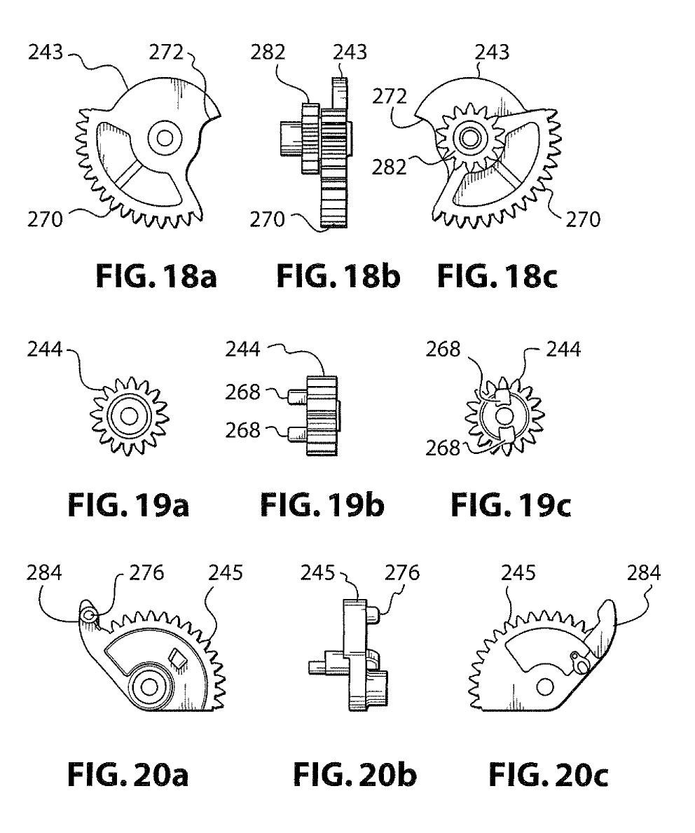

Another embodiment of door release latch apparatus 220 with an emergency release feature is illustrated in FIGS. 11a-11f, employing the various components seen in FIGS. 12a-12c, 13a-13c, 14a-14c, 15a-15c, 16a-16c, 17a-17c, 18a-18c, 19a-19c and 20a-20c. Not all of the various return and biasing springs of apparatus 220 are shown, and, as above, housing 21 is shown notionally in phantom lines. Housing 21 is understood to provide the various reaction forces and axles or shaft mounting points for the various gears and levers noted below.

Latch apparatus 220 includes the following members: a ratchet 222 and ratchet spring 223; a pawl 224, and pawl spring 225; a multi-input pawl lever 226, and pawl lever spring 227; a mechanical energy storage device in the nature of an emergency spring pin 228, which includes its spring 229; an emergency spring retainer 230 and its return spring 231; an actuator 232 that includes a motor 234 and an output gear, identified as worn gear 236; and a set of gears 240 that includes first, second, third fourth and fifth gears 241, 242, 243, 244 and 245 respectively. Gears 242 and 244 are carried on a common shaft. As with the previously described embodiments, an ECU 38 is connected to control operation of apparatus 220, and various switches and interlocks may also be provided as described above to prevent operation unless a door handle is actuated, and to avoid inadvertent actuation in the event of a false signal from ECU 38.

In the first, or normal mode of operation, supposing that a door handle has been activated, and a signal has been received by actuator 232, motor 234 runs to drive worm gear 236 in the clockwise direction (as viewed looking away from the body of motor 234) to drive the large outer gear 246 of first gear 241 clockwise. This necessarily carries the small inner pinion 248 of first gear 241 in the same direction. It then drives second gear 242 counterclockwise, overcoming the clockwise bias of return spring 250 of second gear 242. As this happens, a mechanical signal transmission interface member in the nature of an abutment 252 of second gear 242 moves to contact the first input interface member, or arm 254 of pawl lever 226, this arm 254 having an opposed mating abutment 256. This action drives pawl lever 226 clockwise against the resistance of its own return spring 227 applied at second input interface member, or arm, 258. It also causes the output interface member, namely arm 260, to work against the second end 262 of pawl 224, thus applying a torque tending to rotate pawl 224 clock-wise, and disengaging the ratchet abutment seat 262 of the other arm 264 out of engagement with, and out of the path of, the catch or stop 266 of ratchet 222. As such, ratchet 222 is released and can move in the direction of arrow ‘A’ from the position shown in FIG. 11d to the position shown in FIG. 11f. Gears 244, 243 and 245 do not move given the lost motion between the prongs 268 of gear 244 and the abutments of accommodations 269 of gear 242.

In the second, or emergency, mode as shown in FIGS. 11e and 11f, ECU 38 commands actuator 232 to drive motor 234 in the opposite direction, i.e., counter-clockwise, such that worm gear 236 drives first gear 241 and its outer gear 246 and pinion 248 counter-clockwise. This action moves abutment 252 away from abutment 256. Instead, fourth gear 244, whose drive prongs 268 seat in second gear 242, drives the outer sector gear portion 270 of third gear 243. This forces the end abutment output signal transferring tip of sector arm 272 against the back end input interface 274 of emergency spring retainer 230. Emergency spring retainer 230 pivots about its axis of rotation (and against the default bias of its return spring 231), such that stop 278 moves free of, and out of the path of, the mating stop 280 of emergency spring pin 228. The motion of the inner pinion 282 of third gear 243 has at the same time driven fifth gear 245 clockwise (to the position of gear 245 shown in FIG. 11b), the energy storage reset member, namely emergency spring return cam arm 284, is moved to a retracted position, such that mechanical signal interface member 276 (i.e., the lug on the side of cam arm 284) moves in opposition to the second the second input interface arm 286 of pawl lever 226. Pawl lever 226 is carried along by its return spring 227. Once stop 278 moves, emergency spring pin 228 is free to act against cam arm 284, and hence, through the medium of member 276, against interface arm 286, thereby to release pawl 224 as before.

When driven in the other direction (i.e., after a suitable time lapse after an emergency spring release, motor 234 is driven in the opposite sense to return to the initial position and to reset the device) pinion 282 drives fifth gear 245 in the other direction causing cam arm 284 to ride against the nose of emergency spring pin 228. This forces it backwards to compress spring 229, so storing energy in the spring for the next emergency release, as may be.

Provision is made for a manual reset by use of an hand tool, such as those described above, the use of the tool tending to disengage rotation of the inner pinion of first gear 241 from worm gear 238.

As with the previously described embodiments, it can be seen that there are two mechanical signal transmission paths, corresponding to the first and second (i.e., normal and emergency) modes of operation. The logic algorithms, position switches, timing and logic shown in FIG. 5 and described above also apply to this embodiment.

The principles of the present invention are not limited to these specific examples which are given by way of illustration. It is possible to make other embodiments that employ the principles of the invention and that fall within its spirit and scope of the invention. Since changes in and or additions to the above-described embodiments may be made without departing from the nature, spirit or scope of the invention, the invention is not to be limited to those details.

1. A door latch apparatus comprising:
a ratchet, a co-operating pawl, a primary pawl release, a secondary pawl release, and an actuator;
said ratchet being movable between an open position in which a mating striker can be engaged and disengaged therefrom, and a closed position in which the mating striker is captured thereby;
said pawl being movable between a first position preventing movement of said ratchet from said closed position to said open position, and a second position permitting movement of said ratchet from said closed position to said open position, whereby to permit release of the striker;
said actuator being connected in a first path to cause said primary pawl release to urge said pawl to said second position;
said actuator being connected in a second path to cause said secondary pawl release to urge said pawl to said second position;
said actuator being operable to transmit a release signal along said second path in the event that said pawl is not released when a release signal is transmitted along said first drive path.

2. The door latch apparatus of claim 1 wherein said apparatus includes an energy storage device, and said energy storage device is mounted to urge said pawl to move to said second position when said actuator transmits a signal along said second path.

3. The door latch apparatus of claim 1 wherein said second path includes a mechanical force transformer operable to apply a greater force to urge said pawl to said second position when activated along said second path than along said first path.

4. The door latch apparatus of any one of claim 3 wherein said actuator is operable in a first direction to transmit a signal along said first path, and in a second, opposite, direction to transmit a signal along said second path.

5. The door latch of any one of claim 4 wherein one of (a) said first path; and (b) said second path includes a speed reduction gear train.

6. The latch of any one of claim 5 wherein said apparatus includes a time sensor and a release sensor, and said apparatus is operable to transmit a first mechanical signal along the first path, operable to test for release of the door latch over a period of time, and operable to transmit a second mechanical signal along the second path after expiry of that time period.

7. The door latch of any one of claim 6 wherein at least said second path has a path interrupt, and at least one door handle input member operable to close said path interrupt.

8. The door latch of any one of claim 6 wherein both said first and second paths have a path interrupt, and at least one door handle input member operable to close that interrupt.

9. The door latch of claim 7 wherein said second path has both an inside door handle input member and an outside door handle input member, and either of said input members is operable to close said path interrupt.

10. The door latch of any one of claim 6 wherein both said first and second paths have a respective path interrupt, and both an outside door handle input member and an outside handle input member, either of said handle input members being operable to close said interrupt.

11. The door latch of any one of claim 1 wherein said door latch has an externally accessible reset.

12. The door latch of claim 11 wherein said externally accessible reset is one of (a) a mechanical reset; and (b) an electrical reset.

13. The door latch of claim 2 wherein said actuator is operable to re-energize the energy storage member following transmission of a release signal along said second path.

14. The door latch of claim 2 wherein said energy storage member is an emergency release spring.

15. A latch comprising: a ratchet and pawl assembly; a sector lever; an emergency release spring for urging the sector lever to act against the pawl to release the ratchet; a sector pawl biased to check sector lever from engaging the pawl; and a motorized actuator operable in a first mode to act directly against the pawl to release the ratchet and operable in a second mode to disengage the sector pawl from checking the sector lever.

16. The latch of claim 15 wherein the actuator is operable to reset the latch following operation of the latch in the second mode

17. The latch of claim 15 wherein operation thereof being governed by an ECU.

18. The latch of claim 17 wherein said electronic control unit is programmed to release the latch in the first mode, to wait for a first set time period to sense that the latch is unlatched; if that time period expires without sensing an unlatched condition, then to operate in the second mode.

19. The latch of claim 18 wherein said electronic control unit is programmed to wait a second time period, and then to drive said latch to a reset condition.

20. A latch comprising:
a motorized release actuator, the actuator having an output element;
a catch movable between an engaged position in which the release actuator is precluded from moving even if the motor of the release energizer is actuated and a disengaged position wherein the actuator output is free to move;
said catch being mechanically linked to at least one of (a) an inside door handle and (b) an outside door handle; and
the catch being biased to the engaged position and movable to the disengaged position by a pull on either of the inside or outside door handles.

21. The latch of claim 20 wherein the catch is a mechanical interrupt biased to prevent operation of said actuator unless said at least one handle is activated.

22. A latch comprising:
a ratchet and pawl assembly;
a first gear enabled to act against the pawl to release the ratchet;
a reduction gear set mounted to act against the pawl to release the ratchet; and
a release actuator;
the release actuator being operable in a first direction to activate the first gear to release the pawl and operable being in a second direction to activate the reduction gear set to release the pawl.

23. The latch of claim 22 wherein there is a lost motion connection between the first gear and the reduction gear set.

24. A door system comprising:
inside and outside handles mounted to a door;
a latch having an ECU and an electrically operated door release actuator;
the inside and outside door handles being electrically connected to the ECU and release actuator
a receptacle mounted in one of (a) the interior side of the door and (b) the exterior side of the door, the receptacle having an electrical contact, the receptacle being connected to at least the ECU.

25. The door system of claim 24 and an auxiliary recovery battery having a contact receivable in the receptacle.

26. A latching system in a vehicle having a main battery, an electronic latch having a ratchet and a pawl, and a latch ECU, there being a switch installed between the battery and the ECU, the system including an auxiliary battery connected to the latch ECU, said switch being actuated by the latch ratchet.

27. A latching system in a vehicle having a main battery, the latching system including an electronic latch having a ratchet and a pawl, and a latch ECU, there being an auxiliary battery connected to the latch ECU, and an anti-fuse member installed between the battery and ECU, which anti-fuse device is permanently closed after the main vehicle battery is wired to wires connected to the ECU.

28. A latching system in a vehicle having a main battery, the latching system including an electronic latch having a ratchet and a pawl, and a latch ECU, and at least two switches mounted to inhibit release of the latch, wherein both switches must be activated to permit the latch to open.
